(19) United States
(12) Patent Application Publication
(10) Pub. No.: US 2006/0001611 A1
(43) Pub. Date: Jan. 5, 2006

(54) Plasma display panel

(76) Inventors: Kyung-Doo Kang, Suwon-si (KR); Won-Ju Yi, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/173,576

(22) Filed: Jun. 29, 2005

(30) Foreign Application Priority Data
Jun. 30, 2004 (KR) 10-2004-0050804

(51) Int. Cl. G09G 3/28

(52) U.S. Cl. 345/72

(57) ABSTRACT

A plasma display panel, which effectively compensates for the lowest maximum brightness level of a sub-pixel, is disclosed. In one embodiment, the plasma display panel includes: an upper substrate, a lower substrate facing the upper substrate, an upper dielectric layer formed on the upper substrate, a lower dielectric layer formed on the lower substrate and facing the upper dielectric layer, barrier ribs formed between the upper and lower substrates, and defining red, green, and blue sub-pixels, each sub-pixel including one of red, green, and blue phosphor layers, upper discharge electrodes embedded in the upper dielectric layer, disposed to correspond to the sub-pixels, extending in the same direction and being separated from each other; lower discharge electrodes embedded in the lower dielectric layer, disposed to correspond to the sub-pixels, extending in a direction of crossing the upper discharge electrodes, and being separated from each other; and unit pixels respectively including a set of four sub-pixels, which are divided into two subsets to be disposed at the adjacent upper discharge electrodes, respectively.

### BACKGROUND OF THE INVENTION

This application claims the priority of Korean Patent Application No. 10-2004-0050804, filed on Jun. 30, 2004, in the Korean Intellectual Property Office, the disclosure of which is incorporated herein in its entirety by reference.

1. Field of the Invention

The present invention relates to a plasma display panel, and more particularly, to a plasma display panel having a structure capable of improving a color temperature characteristic.

2. Description of the Related Technology

In general, in a plasma display panel, a glow discharge is generated by applying a predetermined voltage to electrodes installed in a sealed space filled with a gas. Thereafter, a phosphor layer formed in a predetermined pattern is excited by ultraviolet rays, generated due to the glow discharge, and displays an image.

Plasma display panels can be classified into direct current (DC) plasma display panels, alternating current (AC) plasma display panels, and hybrid plasma display panels according to their driving methods. In addition, the plasma display panel can be classified into two-electrode plasma display panels and three-electrode plasma display panels according to the number of electrodes they include. A DC plasma display panel includes an auxiliary electrode in order to induce an auxiliary discharge, and an AC plasma display panel includes an address electrode for improving an address speed by providing an address discharge and a sustain discharge. Also, AC plasma display panels can be classified into opposing discharge plasma display panels and surface discharge plasma display panels according to the arrangement of the electrodes performing the discharge. An AC opposing discharge includes two sustain electrodes for forming the discharge, the sustain electrodes being disposed on two substrates, respectively, to generate the discharge perpendicularly to the panel. An AC surface discharge plasma display panel includes two sustain electrodes that are disposed on one substrate to generate the discharge on a surface of the substrate.

FIG. 1 shows an example of a sub-pixel formed on a conventional surface discharge three-electrode type plasma display panel.

Referring to FIG. 1, in the sub-pixel 10, pairs of sustain electrodes 12 including X electrodes 13 and Y electrodes 14, which are separated from each other to form discharge gaps, are formed on a lower surface of an upper substrate 11. The X and Y electrodes 13 and 14 function as a common electrode and a scan electrode, respectively. The X and Y electrodes 13 and 14, respectively, include transparent electrodes 13a and 14a and bus electrodes 13b and 14b formed on lower surfaces of the transparent electrodes 13a and 14a to apply voltages. The pairs of sustain electrodes 12 are embedded in an upper dielectric layer 15, and a protective layer 16 is formed under the upper dielectric layer 15.

A lower substrate 21 faces the upper substrate 11, and address electrodes 22 are formed on the lower substrate 21. The address electrodes 22 are embedded in a lower dielectric layer 23. Barrier ribs 24 are formed on the lower dielectric layer 23, and a phosphor layer 25 is formed in spaces defined by the barrier ribs 24. A discharge gas is injected into the sub-pixel 10 having the above structure.

Operations of the plasma display panel including the sub-pixels 10 having the above structure will be described.

When an address voltage is applied between the address electrode 22 and the Y electrode 14, an address discharge occurs, and accordingly, predetermined wall charges are generated in the addressed sub-pixel 10. In addition, a sustain voltage is applied between the X electrode 13 and the Y electrode 14 to generate a sustain discharge. The electric charges generated by the discharge collide with the discharge gas, plasma is generated due to the collisions, and accordingly, ultraviolet rays are generated by the plasma. The phosphor layer 25 is excited by the ultraviolet rays, and then, emits visible lights to display an image.

One of red, green, and blue color phosphor materials is disposed in the sub-pixel for displaying colors, thus the sub-pixels 10 can be divided into red sub-pixels 10R, green sub-pixels 10G, and blue sub-pixels 10B as shown in FIG. 2. Three of the red, green, and blue sub-pixels 10R, 10G, and 10B form a unit pixel 30, and various colors can be displayed by combining three primitive colors. In more detail, if brightnesses of the red, green, and blue lights emitted from the red, green, and blue sub-pixels 10R, 10G, and 10B are, respectively, divided into, for example, 256 grades and the divided red, green, and blue lights are combined, about 16,770,000 colors can be displayed from the unit pixel 30.

However, generally under the same conditions, the maximum brightness level of the green light is the highest, and the maximum brightness level of blue light is the lowest. Since the blue light has the lowest maximum brightness level, a color temperature of white light that is represented by combining the red, green, and blue lights of maximum brightnesses is low, and thus the maximum brightness of the mixed light is reduced.

Therefore, there has been a need to effectively compensate for the lowest maximum brightness level of the blue light.

### SUMMARY OF CERTAIN INVENTIVE ASPECTS

One aspect of the present invention provides a plasma display panel, in which each unit pixel includes a red, a green, and a blue sub-pixel and an additional sub-pixel that has the same brightness level as the sub-pixel having the lowest maximum brightness level among the red, green, and blue sub-pixels, in order to improve color temperature characteristics of the panel and maximize brightness of the light emitted by the unit pixels.

Another aspect of the present invention provides a plasma display panel including: an upper substrate, a lower substrate facing the upper substrate, an upper dielectric layer formed on the upper substrate, a lower dielectric layer formed on the lower substrate and facing the upper dielectric layer, barrier ribs formed between the upper and lower substrates, and defining red, green, and blue sub-pixels, each sub-pixel including one of red, green, and blue phosphor layers, upper discharge electrodes embedded in the upper dielectric layer, disposed to correspond to the sub-pixels, extending in the same direction and being separated from each other, lower discharge electrodes embedded in the lower dielectric layer, disposed to correspond to the sub-pixels, extending in a direction crossing the upper discharge electrodes, and being separated from each other; and unit pixels respectively including a set of four sub-pixels, which are divided into two subsets to be disposed at the adjacent two upper discharge electrodes respectively.

### BRIEF DESCRIPTION OF THE DRAWINGS

Embodiments of the present invention will be described with reference to the attached drawings.

FIG. 1 is a cross-sectional view of a sub-pixel according to the conventional art.

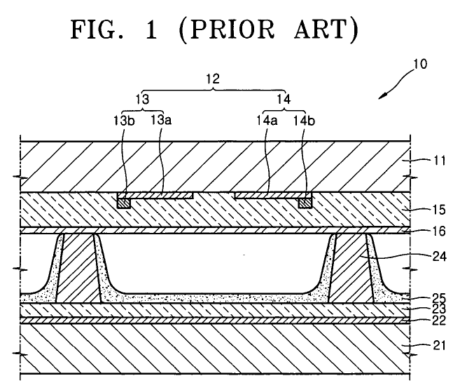

FIG. 2 is a partial plan view of a unit pixel including sub-pixels according to FIG. 1.

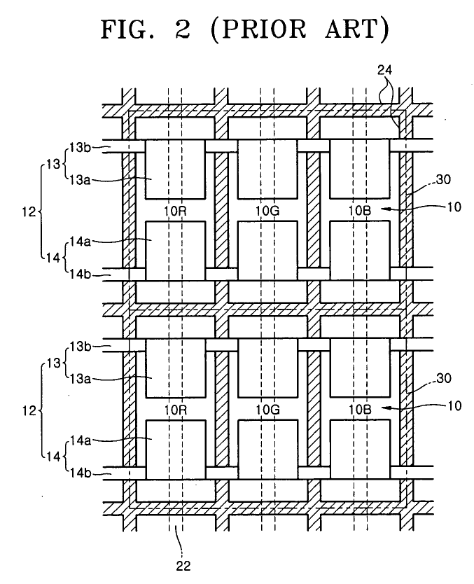

FIG. 3 is a partial perspective view of a plasma display panel according to an embodiment of the present invention.

FIG. 4 is a cross-sectional view of the plasma display panel taken along line IV-IV of FIG. 3.

FIG. 5 is a partial plan view of an example of an arrangement of the sub-pixels of FIG. 3 to form a unit pixel.

FIG. 6 is a partial plan view of another example of the arrangement of the sub-pixels of FIG. 3 to form the unit pixel.

FIG. 7 is a partial plan view of still another example of the arrangement of the sub-pixels of FIG. 3 to form the unit pixel.

### DETAILED DESCRIPTION OF CERTAIN INVENTIVE EMBODIMENTS

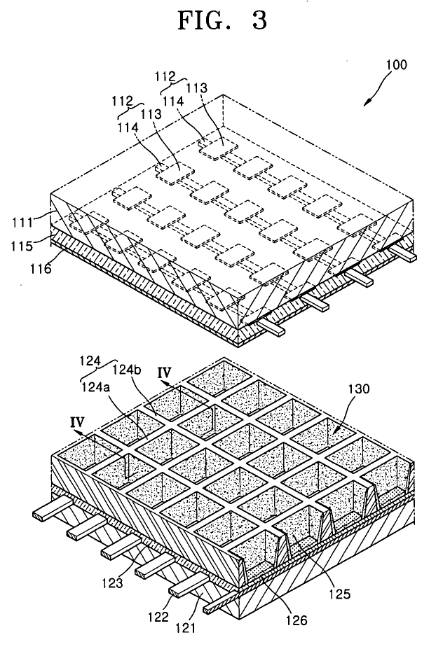

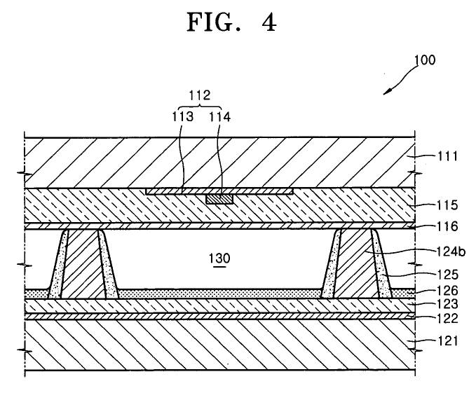

FIG. 3 is a partial perspective view of a plasma display panel according to an embodiment of the present invention, and FIG. 4 is a cross-sectional view of the plasma display panel taken along line IV-IV of FIG. 3.

Referring to FIGS. 3 and 4, the plasma display panel 100 includes an upper substrate 111 and a lower substrate 121 facing the upper substrate 111 and coupled to the upper substrate 111.

In one embodiment, the upper substrate 111 is formed of a transparent material such as glass, through which visible lights can be transmitted to display an image.

Upper discharge electrodes 112 that are separated from each other are disposed on a lower surface of the upper substrate 111. In addition, each of the upper discharge electrodes 112 includes transparent electrodes 113 disposed at sub-pixels 130, and a bus electrode 114 connected to the transparent electrodes 113.

In one embodiment, the transparent electrode 113 has a larger discharge area than that of the bus electrode 114, and thus the panel 100 can operate with low voltage and a brightness of the panel 100 improves. In one embodiment, the transparent electrodes 113 can be formed of a transparent material such as indium tin oxide (ITO) to allow visible lights emitted from a phosphor layer 125 to be transmitted through the upper substrate 111.

The bus electrode 114, which receives voltages from a driving unit, supplies voltages to the transparent electrodes 113. In one embodiment, the bus electrode 114 is formed of a metal having high conductivity, for example, Ag or Cu, in order to improve electric resistances of the transparent electrodes 113 that are formed of the ITO having relatively lower conductivity.

The bus electrode 114, which has generally a width narrower than that of the transparent electrode 113, is connected to center portions of the transparent electrodes 113 and extends in a direction of crossing lower discharge electrodes 122. In one embodiment, the bus electrode 114 is disposed at the center portion of the transparent electrodes 113. In another embodiment, the bus electrode can be disposed at end portions of the transparent electrodes 113.

The upper discharge electrodes 112 are embedded in an upper dielectric layer 115 formed of a dielectric material such as PbO, B₂O₃, or SiO₂. The upper dielectric layer 115 prevents charged particles from directly colliding onto the upper discharge electrodes 112 during a discharge and the upper discharge electrodes 112 from being damaged by the collision, and induces the charged particles. In one embodiment, the lower surface of the upper dielectric layer 115 is covered by an upper protective layer 116 formed of, for example, MgO. The upper protective layer 116 prevents the charged particles from directly colliding onto the upper dielectric layer 115 during the discharge, and emits secondary electrons when the charged particles collide thereto in order to improve discharge efficiency.

The lower discharge electrodes 122 extend perpendicularly to the upper discharge electrodes 112 on the upper surface of the lower substrate 121 facing the upper substrate 111 and are separated predetermined distances from each other, and thus these are arranged in stripes. The lower discharge electrodes 122 are embedded in a lower dielectric layer 123, and barrier ribs 124 are formed on the lower dielectric layer 123 in a predetermined pattern.

The barrier ribs 124 define sub-pixels 130, and prevent cross talk from being generated between neighboring sub-pixels 130. The barrier ribs 124 include first barrier ribs 124a that are parallel to and separated from each other, and second barrier ribs 124b that are perpendicular to the first barrier ribs 124a, and parallel to and separated from each other on the same plane as that of the first barrier ribs 124a. Thus, the sub-pixels 130 are of a closed type. Here, the first barrier ribs 124a extend parallel to the lower discharge electrodes 122, and the lower discharge electrodes 122 can be disposed between the first barrier ribs 124a one by one. The barrier ribs 24 are not limited to the above example, and can be formed to have various shapes such as stripe.

The phosphor layer 125 that is excited by the ultraviolet rays generated during the discharge to emit the visible lights is disposed in the sub-pixels 130 defined by the barrier ribs 124. In one embodiment, the phosphor layer 125 is formed on side surfaces of the barrier ribs 124. In another embodiment, the phosphor layer 125 can be formed on other portions, for example, the bottom of each discharge cell. The phosphor layer 125 can be formed of one of red, green, and blue color phosphor materials for realizing the colors, and accordingly, the phosphor layer 125 can be classified into red, green, and blue phosphor layers.

In the lower dielectric layer 123, on which the barrier ribs 124 and the phosphor layer 125 are formed in a predetermined pattern, a lower protective layer 126 is formed on the upper surface of the lower dielectric layer 123 where the barrier ribs 124 and the phosphor layer 125 are not formed. Like the upper protective layer 116, the lower protective layer 126 prevents the charged particles from colliding onto the lower dielectric layer 123 and the lower dielectric layer 123 from being damaged by the collision, and emits secondary electrons when the charged particles collided thereto, thus improving the discharge efficiency. In one embodiment, the lower protective layer 126 can be formed of MgO. Otherwise, the lower protective layer 126 can be formed on entire upper surface of the lower dielectric layer 123, and accordingly, the barrier ribs 124 and the phosphor layer 125 can be formed on the lower protective layer 126. The discharge gas, a mixture of, for example, Ne and Xe is filled in the sub-pixels 1-30.

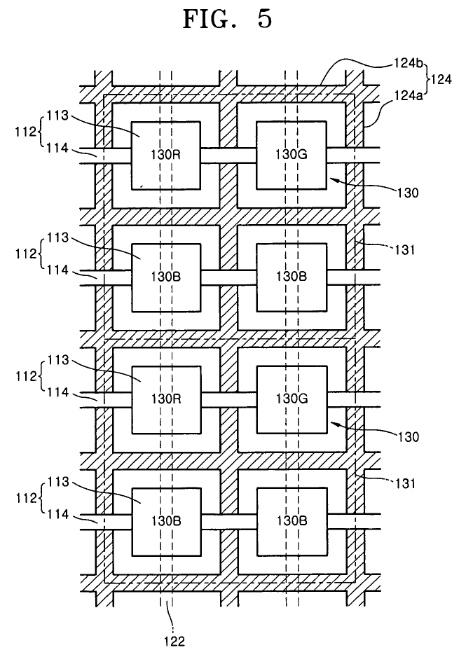

Referring to FIG. 5, the sub-pixels 130 can be classified into red sub-pixels 130R, green sub-pixels 130R, and blue sub-pixels 130B according to the emitting color of phosphor layer 125 disposed in that sub-pixels. The red, green, and blue sub-pixels 130R, 130G, and 130B are included in a unit pixel 131 to display various colors by combining the three primitive colors.

According to one embodiment of the present invention, the unit pixel 131 includes four sub-pixels 130 that are disposed adjacent to each other. That is, the four sub-pixels 130 constituting the unit pixel 131 are arranged around a crossing point of the first barrier rib 124a and the second barrier rib 124b. The four sub-pixels 130 are divided into two units or subsets, which correspond to two adjacent upper discharge electrodes 112, respectively.

In one embodiment, the four sub-pixels 130 are the red, green, and blue sub-pixels 130R, 130G, and 130B, and another sub-pixel 130 that has the same brightness level with the sub-pixel 130 having the lowest maximum brightness level among the red, green, and blue sub-pixels 130R, 130G, and 130B. When the sub-pixel 130 having the lowest maximum brightness level is further added in the unit pixel 131, the maximum brightness of the visible light having the lowest maximum brightness level can be increased. Accordingly, the color temperature characteristic of white light that is represented by combining the red, green, and blue lights of maximum brightnesses from the unit pixel can be improved, and the maximum brightness characteristic of the unit pixel 131 can be improved.

Generally, under the same conditions, the maximum brightness level of the green light is the highest, and the maximum brightness level of the blue light is the lowest. Thus, the other sub-pixel 130 having the lowest maximum brightness level can be the blue sub-pixel 130B. As described above, if two blue sub-pixels 130B are included in the unit pixel 131, the maximum brightness of the blue light can be increased. Therefore, the color temperature of the white light that is represented by combining the red, green, and blue lights of maximum brightnesses from the unit pixel 31 can be increased, and the maximum brightness of the unit pixel 131_can also be increased.

Depending on embodiments, the four sub-pixels 130 constituting the unit pixel 131 can be arranged in various patterns. For example, in one embodiment as shown in FIG. 5, the red sub-pixel 130R, green sub-pixel 130G, blue sub-pixel 130B, and another blue sub-pixel 130B are arranged around the crossing point of the first barrier rib 124a and the second barrier rib 124b in a clockwise direction.

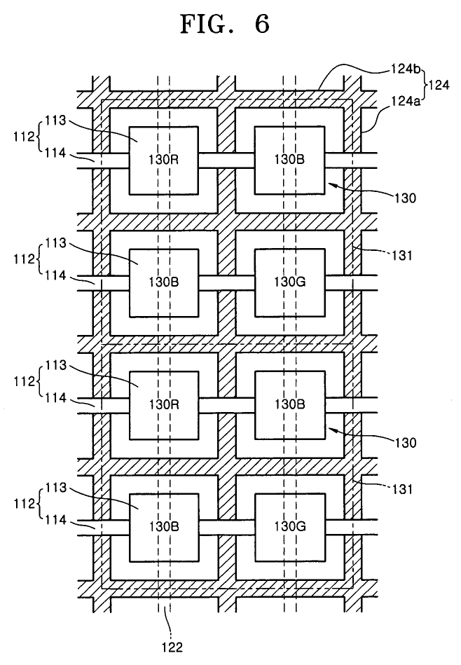

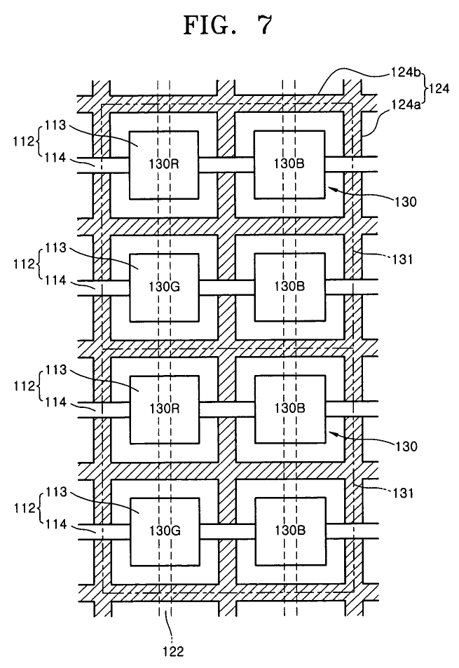

In another embodiment as shown in FIG. 6, the sub-pixels 130 can be arranged in the order of the red sub-pixel 130R, blue sub-pixel 130B, green sub-pixel 130G, and another blue sub-pixel 130B around the crossing point of the first barrier rib 124a and the second barrier rib 124b in the clockwise direction. In another embodiment as shown in FIG. 7, the sub-pixels 130 can be arranged in the order of the red sub-pixel 130R, blue sub-pixel 130B, another blue sub-pixel 130B, and green sub-pixel 130G around the crossing point of the first barrier rib 124a and the second barrier rib 124b in the clockwise direction.

The operation of a plasma display panel having the above structure is as follows.

One of the upper discharge electrode 112 and the lower discharge electrode 122 functions as a scan and sustain electrode, and the other functions as an address and sustain electrode. When the upper discharge electrode 112 functions as the scan and sustain electrode and the lower discharge electrode 122 functions as the address and sustain electrode, the scan voltage is applied to the upper discharge electrode 112 and the address voltage is applied to the lower discharge electrode 122. Then, the address discharge occurs at the sub-pixel corresponding to the crossing point between the upper and lower discharge electrodes 112 and 122. After the address discharge, when a sustain voltage is alternately applied between the upper and lower discharge electrodes 112 and 122, the charged particles reciprocate in an up-and-down direction and the sustain discharge occurs. The discharge gas emits ultraviolet rays by the sustain discharge, and the phosphor layer 125 disposed in the sub-pixel 130 is excited by the ultraviolet rays. As such, the excited phosphor layer 125 emits visible light.

As described above, according to embodiments of the present invention, each unit pixel in a plasma display panel includes red, green, and blue sub-pixels, and an additional sub-pixel that has the same maximum brightness level as the sub-pixel having the lowest maximum brightness level, and thus the color temperature of white light emitted by the unit pixel can be improved. In addition, the brightness of the plasma display panel can be maximized.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A plasma display panel, comprising:
an upper substrate;
a lower substrate facing the upper substrate;
an upper dielectric layer formed on the upper substrate;
a lower dielectric layer formed on the lower substrate and facing the upper dielectric layer;
barrier ribs formed between the upper and lower substrates, and defining red, green, and blue sub-pixels, each sub-pixel including one of red, green, and blue phosphor layers;
upper discharge electrodes embedded in the upper dielectric layer, disposed to correspond to the sub-pixels, extending in a first direction and being separated from each other;
lower discharge electrodes embedded in the lower dielectric layer, disposed to correspond to the sub-pixels, extending in a second direction substantially perpendicular to the first direction, and being separated from each other; and
unit pixels each including a set of four sub-pixels, which are divided into two subsets to be disposed at two adjacent upper discharge electrodes, respectively.

2. The plasma display panel of claim 1, wherein each unit pixel includes a red sub-pixel, a green sub-pixel, a blue sub-pixel, and another sub-pixel that has the same brightness level as the sub-pixel having the lowest maximum brightness level among the red, green, and blue sub-pixels.

3. The plasma display panel of claim 2, wherein the other sub-pixel is a blue sub-pixel.

4. The plasma display panel of claim 3, wherein the barrier ribs include first barrier ribs separated from each other and extending parallel to the lower discharge electrodes, and second barrier ribs separated from each other and extending substantially perpendicularly to the first barrier ribs on the same plane with the first barrier ribs.

5. The plasma display panel of claim 4, wherein the sub-pixels constituting each unit pixel are arranged around a crossing point of one of the first barrier ribs and one of the second barrier ribs.

6. The plasma display panel of claim 5, wherein each of the unit pixels includes the sub-pixels that are arranged in a clockwise direction in an order of the red sub-pixel, green sub-pixel, blue sub-pixel, and another blue sub-pixel around the crossing point of the first barrier ribs and the second barrier ribs.

7. The plasma display panel of claim 5, wherein each of the unit pixels includes the sub-pixels that are arranged in a clockwise direction in an order of the red sub-pixel, blue sub-pixel, green sub-pixel, and another blue sub-pixel around the crossing point of the first barrier rib and the second barrier ribs.

8. The plasma display panel of claim 5, wherein each of the unit pixels includes the sub-pixels that are arranged in a clockwise direction in an order of the red sub-pixel, blue sub-pixel, another blue sub-pixel, and green sub-pixel around the crossing point of the first barrier rib and the second barrier ribs.

9. The plasma display panel of claim 1, wherein each of the upper discharge electrodes includes a transparent electrode and a bus electrode connected to the transparent electrode and extending in a direction of crossing the lower discharge electrodes.

10. The plasma display panel of claim 1, further comprising a phosphor layer disposed at side surfaces of the barrier ribs.

11. The plasma display panel of claim 1, further comprising an upper protective layer covering a lower surface of the upper dielectric layer.

12. The plasma display panel of claim 1, further comprising a lower protective layer covering an upper surface of the lower dielectric layer.

13. A plasma display panel, comprising:
a plurality of barrier ribs, formed between first and second substrates opposing each other, configured to define a plurality of discharge cells, wherein visible light is transmitted through the first substrate, and wherein each discharge cell contains one of red, green, and blue phosphor layers associated with red, green, and blue sub-pixels, respectively;
a plurality of first discharge electrodes formed on the first substrate;
a plurality of second discharge electrodes formed on the second substrate; and
a plurality of unit pixels each including a set of four sub-pixels, which are divided into two subsets to be disposed at two adjacent first discharge electrodes, respectively.

14. The plasma display panel of claim 13, wherein each unit pixel includes a red sub-pixel, a green sub-pixel, a blue sub-pixel, and another selected sub-pixel that has the same brightness level as the sub-pixel having the lowest maximum brightness level among the red, green, and blue sub-pixels.

15. The plasma display panel of claim 14, wherein the selected sub-pixel is a blue sub-pixel.

16. A structure for a plasma display panel, the structure comprising:
a plurality of discharge cells, wherein red, green and blue phosphor layers, and another selected phosphor layer, formed within respective discharge cells, form a unit pixel which is configured to provide various colors based on the combination of red, green and blue, and wherein only two discharge electrodes are associated with each color phosphor layer.

17. A plasma display panel, comprising:
a plurality of unit pixels, each unit pixel including sub-pixels of red, green, blue and another selected color, corresponding to a red, green, blue and another selected color phosphor layer formed within discharge cells, respectively, wherein each unit pixel comprises a first pair of sub-pixels and a second pair of sub-pixels and is configured to provide various colors based on the combination of red, green, blue and the other selected colors, and wherein the first and second pairs of sub-pixels are arranged in parallel to each other.

18. The plasma display panel of claim 17, wherein the panel is a two-electrode plasma display panel.

19. The plasma display panel of claim 17, wherein the other sub-pixel is a blue sub-pixel.

20. The plasma display panel of claim 19, wherein the sub-pixels of each unit pixel are arranged in a clockwise direction in the order of one of the following: (Red, Green, Blue, Blue), (Red, Blue, Green, Blue) and (Red, Blue, Blue, Green).
